(19) United States
(12) Patent Application Publication
(10) Pub. No.: US 2006/0256941 A1
(43) Pub. Date: Nov. 16, 2006

(54) Terminal independent personal telephone services

(76) Inventor: Ari Kahn, Mt. Shasta, CA (US)

Correspondence Address: BOOTH UDALL, PLC, 1423 S. HIGLEY ROAD, SUITE 110, MESA, AZ, 85206, US

(21) Appl. No.: 10/551,154

(22) PCT Filed: Mar. 31, 2004
(86) PCT No.: PCT/IB04/00965

§ 371 Date: Sep. 28, 2005

(30) Foreign Application Priority Data
Mar. 31, 2003 (ZA) 2003/2504

(51) Int. Cl. H04M 15/00

(52) U.S. Cl. 379/114.01

(57) ABSTRACT

The invention provides a communication system comprising a network infrastructure and a plurality of telephone terminals. The telephone terminals can be conventional telephones. The network infrastructure includes a control center with an associated database, which stores data corresponding to telephone numbers allocated to subscribers. The database also stores respective subscriber identity codes. A user of the system can use any conventional telephone to access the system and enters a predetermined access code, their telephone number and their identity code. If the entered information is validated, the network maps the subscriber's telephone number to the telephone in use, which is effectively converted temporarily to the subscriber's own personal telephone.

### BACKGROUND OF THE INVENTION

THIS invention relates to a method of operating a communication system comprising a network infrastructure and a plurality of telephone terminals. The invention further relates to such a communication system itself and to data storage tokens for use in the method and system.

Despite the provision of fixed telephone terminal (landline) facilities to a significant proportion of the population, and the adoption of mobile telephones by significant numbers of users, large numbers of people do not have access to a personal telephone service and are at best reliant on public telephones or the use of telephones belonging to others. This is not only unsatisfactory for the affected individuals, but also has the effect that they are to a large extent uncontactable by others via existing telephone systems.

It is an object of the invention to provide a method and system which address this situation.

### SUMMARY OF THE INVENTION

According to the invention there is provided a method of operating a communication system comprising a network infrastructure and a plurality of telephone terminals, the method comprising:
allocating a telephone number to each of a plurality of subscribers;
recording an identity code associated with each subscriber;
receiving data, entered via a telephone terminal, corresponding to the identity code of a subscriber; and
enabling the telephone terminal to make calls and to receive calls made to the telephone number of said subscriber.

The method may comprising entering data via a keypad of the telephone terminal, for example.

Alternatively, the data may be entered from a data storage token via a token reader associated with the telephone terminal, such as a smart card reader or inductive card reader.

For example, the data storage token may carry data including the subscriber's telephone number and identity code.

The enabling of the telephone terminal to make calls preferably includes the enabling of billing of the subscriber for calls made from the enabled telephone terminal.

The subscriber may have an account, which may be a prepaid account or a credit account, with the operator of the communications network which can be billed for calls made.

Alternatively, or in addition, the subscriber may have a data storage token storing a credit value, the telephone terminal being operable to read the credit value from the token, to enable the telephone terminal if the credit value exceeds a predetermined value, and to reduce the credit value according to the cost of the calls made.

Further according to the invention there is provided a communication system comprising:
a network infrastructure including a plurality of network nodes through which telephone terminals can access the network infrastructure;
a control center with an associated database, the database storing data corresponding to telephone numbers allocated to subscribers to the system and respective subscriber identity codes, the control center being operable, on receipt of a valid identity code, to transmit a terminal enabling signal; and
a plurality of telephone terminals, each telephone terminal being operable to receive data corresponding to the identity code of a subscriber to the system and to transmit said data to the control center via a network node, the telephone terminal being enabled, in response to the receipt of the terminal enabling signal by the respective network node, to make and receive calls via the network infrastructure.

Each telephone terminal may include a token reader such as a smart card reader or an inductive card reader arranged to read data from a data storage token presented by a subscriber.

The system may include a billing center which monitors calls made by subscribers and charges the calls to subscribers' accounts.

Alternatively, or in addition, at least some of the terminals may include a token reader/writer operable to read a credit value from a data storage token presented by a subscriber, and a processor operable to enable the telephone if the credit value exceeds a predetermined value and to cause the token reader/writer to reduce the credit value according to the cost of calls made.

Depending on the form of the token, the token reader could be, for example, a magnetic card reader, an optical card reader, a smart card reader, or a non-contact card reader such as an inductive card reader, or the like.

Still further according to the invention there is provided a data storage token for use in the communication system defined above, the token comprising:
a substrate;
a data storage element for storing data defining a telephone number allocated to a subscriber to the system; and
an interface operable to transfer data to a telephone terminal of the system to identity the subscriber to the system.

Preferably the data storage element is arranged to store, in addition to data defining the subscriber's telephone number, data defining an identity code associated with the subscriber.

The identity code may take the form of a user-selected personal identity number (PIN) or a similar security code.

The data storage element may further be arranged to store data defining user information to be transmitted to the recipient of a call made by the subscriber, to identity the subscriber to the recipient, for example, by a caller line identity (CLI) system.

The user information may be determined by the subscriber.

The data storage element may store data corresponding to a credit value, the interface being operable to increase or decrease the credit value.

The token will typically be a smart card or an inductive data storage card.

### BRIEF DESCRIPTION OF THE DRAWINGS

FIG. 1 is a highly simplified schematic diagram of a communication system according to the invention;

FIG. 2 is a pictorial view of a smart card used in the method and system of the invention; and

FIGS. 3 is a simplified flowchart showing major steps in the method of the invention.

### DESCRIPTION OF EMBODIMENTS

The present invention is based on the realisation that it is not necessary for a user of or a subscriber to a communication system to have his/her own telephone terminal on a full time basis. Individuals can be allocated a telephone number which is unique to them, and the communication system can be adapted to allow the subscriber to make and receive calls using an existing telephone terminal with another, different telephone number. Effectively, the existing telephone terminal is temporarily converted into the personal telephone terminal of the subscriber, allowing the subscriber to make calls emanating from and receive calls to his/her own telephone number, and to be billed accordingly. Billing of the subscriber can be by way of an account, whether a credit or prepaid account, or prepaid tokens, for example.

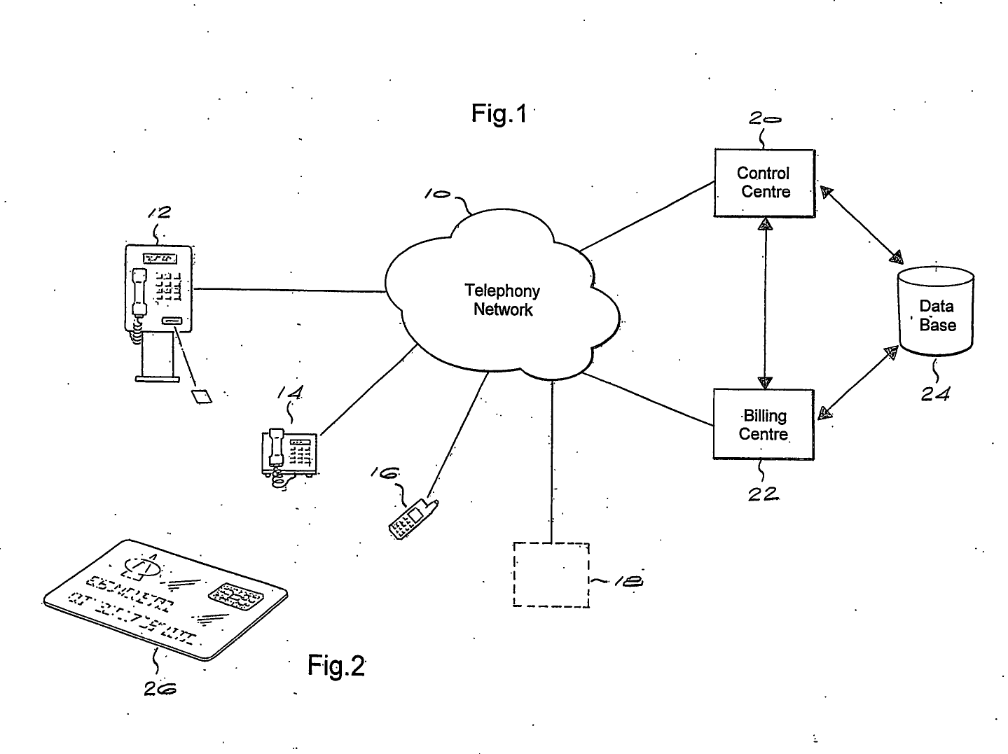

Referring now to FIG. 1, a communication system according to the invention is shown in a highly simplified schematic form. The system is based around a generally conventional telephony network 10, which can be a conventional land line telephone network, a mobile telephone network, or another network that supports telephone calls from one telephone terminal to another via the network infrastructure.

Preferably, the network 10 is an intelligent network (IN), meaning that it comprises distributed intelligence including a database that is queried for information necessary for call processing. For example, a network node such as a mobile communication switch or Mobile Switching Center (MSC) that is equipped with mobile IN call logic, can launch a message or “query” to a database hosted by a network element or node called a Service Control Point (SCP). The SCP processes the request and issues a “response” to the MSC so that it may continue call processing as appropriate.

The use of an intelligent network allows conventional telephone terminals to be used to implement the method and system of the invention, rather than requiring terminals with special functionality. The network nodes through which the telephone terminals access the network provide the necessary functionality and logic.

A number of telephone terminals are shown connected to the network 10. Firstly, a public pay telephone 12 is shown, which includes a smart card reader or another token reader or reader/writer. Conventionally, public telephones are provided with smart card reader/writers which can read a credit balance stored on a user's smart card, and reduce the credit balance according to the calculated cost of a call made by the user. In one version of the present invention, such public telephone terminals can be used unmodified to implement the invention. In other embodiments, the public telephone terminals are modified by the inclusion of alternative or additional token readers, such as non-contact inductive readers which transfer data to and read data from a memory card which is held adjacent to the reader. This is discussed in greater detail below.

A conventional telephone 14 is also shown connected to the network 10. Again, the telephone 14 may be used unmodified, or may be modified by the inclusion of a smart card reader or other reader as discussed above. A mobile telephone 16 is also shown connected to the network 10. In such a case, the network 10 would be wholly or at least partially a mobile telephone network. Finally, an unidentified telephone terminal 18, shown in dotted outline, is also connected to the network 10. The telephone terminal 18 may be any other terminal which permits a telephone call to be made via the network 10. Thus, in the context of the present invention, the phrase “telephone terminal” will be understood to include conventional telephone instruments, public telephones, mobile telephones, and other devices usable to make telephone calls.

A control center 20 is connected to the network 10, together with an associated billing center 22, both of which access data in a database 24. The database stores information corresponding to telephone numbers which have been allocated to subscribers to the system and respective subscriber identity codes, as well as associated subscriber details such as address and account/billing details.

In order to make use of the method and system of the invention, a subscriber to the system registers with the network operator and is allocated a unique personal telephone number. The subscriber is allocated, or chooses, a personal identity number (PIN) or identity code. Personal details of the subscriber are recorded. Optionally, the subscriber can open an account with the network operator, allowing billing of the subscriber in a generally conventional way, or the subscriber can choose to operate on a prepaid basis, for example, utilising prepaid smart cards, a prepaid account, or other conventional prepaid systems.

In the most basic version of the invention, the customer is simply provided with the telephone number and identity code for use with conventional telephone terminals. In more advanced implementations of the invention, the customer can be provided with a smart card, inductive data storage card or other data storage token on which the subscriber's telephone number and, optionally, other data are recorded. For example, the customer's PIN code, personal details and other data relating to service options selected by the customer could be recorded on the data storage token. Because the data storage token is secure, the customer's PIN can be stored on the token, facilitating quick offline authentication of the subscriber. Instead, the subscriber's PIN code could be stored in the database 24, requiring a telephone terminal to transmit a PIN code entered by the subscriber to the control center for verification before authentication can take place.

Operation of the system, in one exemplary embodiment, is as follows. A subscriber wishing to make a call, to receive stored messages or to access the network for other reasons (for example, to check account details) selects a telephone terminal. If the telephone terminal is a completely conventional public telephone, standard telephone or mobile telephone, the user lifts the handset or presses the “call” button and enters a predetermined code which is recognised by the respective node of the intelligent network as an enquiry which is routed to the control center 20. For example, the predetermined code could be a sequence of digits. The subscriber now enters his/her telephone number and PIN. If the entered PIN and entered telephone number correspond to the numbers in the database, the control center transmits a terminal enabling signal to the relevant network node via which the telephone terminal is accessing the network, enabling the telephone terminal to make and receive calls via the network infrastructure. The subscriber's telephone number is mapped by the network to the telephone number of the telephone terminal being used, and that telephone terminal is effectively converted temporarily to the personal telephone of the subscriber, to make and receive calls, access voicemail and use other network functionality as required.

The subscriber's own account, if it exists, is billed for these activities. Alternatively, in the case where a prepaid token is used, the credit balance on the token is reduced according to the calls made and services used. The network is configured to permit incoming calls made to the subscriber's number to be routed to the telephone terminal indefinitely or for a predetermined period after the last use thereof by the subscriber, until a new subscriber's telephone number and PIN code are entered, or a conventional outgoing call is made from the telephone. If the subscriber authenticates a different terminal before either of the above events occurs, the previously used terminal will revert to its conventional function.

In a more sophisticated embodiment of the invention, the subscriber is issued with a data storage token 26 such as that shown in FIG. 2. The data storage token 26 will typically be a smart card. Such cards can have contacts on the surface thereof, requiring insertion into a smart card reader to make a direct connection between the reader and the electronic circuit of the card, or may be contactless cards which require only close proximity (a few centimeters) to a reader for data transfer between the card and the reader. Such cards are generally credit card sized and are well known as such to those skilled in the art.

The smart cards could be Integrated Circuit (IC) microprocessor cards, which support adding, deleting, or manipulating information in memory, allowing for a variety of applications and dynamic read/write capabilities, or IC memory cards, which can store data, but do not have a processor on the card.

Typically, the card 26 is printed with the name of the subscriber and the subscriber's unique telephone number.

Assuming that the subscriber has access to a telephone terminal which is provided with a suitable token reader, the subscriber inserts the smart card or touches the inductive data storage card to the reader, transferring data identifying the subscriber to the network. If the customer's PIN code is stored on the card, the customer can enter the code via a keypad of the telephone terminal and be authenticated offline, in which case the customer's data, typically the customer's unique telephone number, is transmitted to the control center 20, which then maps the customer's telephone number to the existing telephone number of the terminal as described above. Alternatively, the PIN code may be transmitted to the control center for verification against data held in the database 24.

The mapping of the subscriber's telephone number to the terminal's number effectively transforms the terminal into the subscriber's own personal, “virtual” telephone. Calls made from the mapped terminal appear to recipients with caller line identification (CLI) to come from the subscriber's number, and calls to that number ring on the mapped terminal. The subscriber can use the terminal to access all normal network functions such as voicemail, prepayment services and the like. This is facilitated by the functionality of the intelligent network 10.

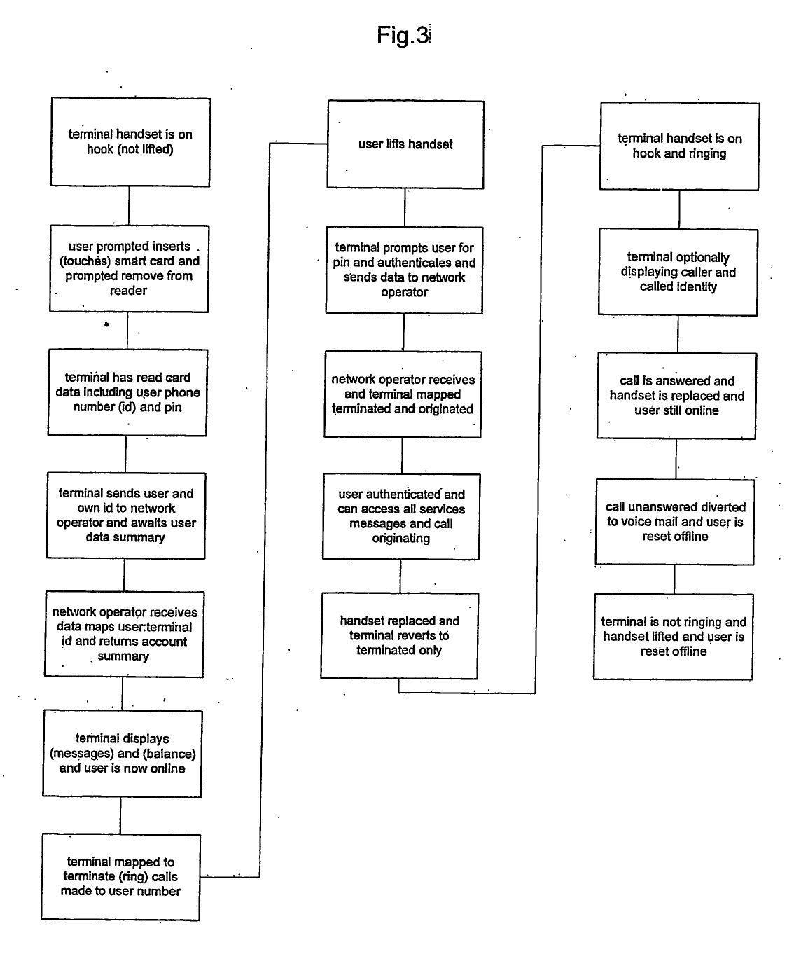

The flowchart of FIG. 3 illustrates the operation of the system in a step by step fashion, based on the use of a data storage token by the subscriber.

It will be appreciated that not all possible variations of the method and system of the invention have been described above, but numerous variations of the inventive concept are possible.

In one enhancement of the invention, the data storage token 26 can be provided with a receiver which is able to receive data transmitted, for example, via a conventional mobile telephony network. In such a case, the token can be provided with a miniature battery and be fitted with one or more LEDs. The network can then transmit data to the token indicative of the fact that there are one or more voicemail messages for the subscriber, causing an LED to flash intermittently. Instead of LEDs, other indicators could be used.

It will be appreciated that the invention makes it possible for individuals who do not have access to a land line telephone service or a mobile telephone to use an existing telephone as if the existing telephone was their own, and to make and receive calls on their own telephone number. Thus, the invention leverages existing telephone networks and provides enhanced access to telephone services for individuals who otherwise would not have such access. Compared with known “virtual” telephone networks, which use existing network infrastructure to offer a telephone service, the invention introduces the further concept of a “virtual telephone terminal”, doing away with the need for network users or subscribers to have their own, dedicated telephone. However, all normal functionality associated with modern telephone networks can be provided, including voicemail, prepaid or account-based billing, caller line identification and the like.

1. A method of operating a communication system comprising a network infrastructure and a plurality of telephone terminals, the method comprising:
allocating a telephone number to each of a plurality of subscribers;
recording an identity code associated with each subscriber;
receiving data, entered via a telephone terminal, corresponding to the identity code of a subscriber; and
enabling the telephone terminal to make calls from and to receive calls made to the telephone number of said subscriber.

2. A method according to claim 1 comprising entering data via a keypad of the telephone terminal.

3. A method according to claim 1 comprising entering data from a data storage token via at least one of a token reader, a smart card reader and an inductive card reader associated with the telephone terminal.

4. (canceled)

5. A method according to claim 1 wherein the data includes the subscriber's telephone number and identity code.

6. A method according to claim 5 wherein the enabling of the telephone terminal to make calls includes the enabling of billing of the subscriber for calls made from the enabled telephone terminal.

7. A method according to claim 6 wherein the subscriber has an account with the operator of the communications network which can be billed for calls made.

8. A method according to claim 7 wherein the account is a prepaid account.

9. A method according to claim 7 wherein the account is a credit account.

10. A method according to claim 7 wherein the telephone terminal is enabled for the subscriber if a credit value associated with the account exceeds a predetermined value, wherein the credit value is reduced according to the cost of the calls made.

11. A communication system comprising:
a network infrastructure including a plurality of network nodes through which telephone terminals can access the network infrastructure;
a control center with an associated database, the database storing data corresponding to telephone numbers allocated to subscribers to the system and respective subscriber identity codes, the control center being operable, on receipt of a valid identity code, to transmit a terminal enabling signal; and
a plurality of telephone terminals, each telephone terminal being operable to receive data corresponding to the identity code of a subscriber to the system and to transmit said data to the control center via a network node, the telephone terminal being enabled, in response to receipt of the terminal enabling signal by the respective network node, to make and receive calls via the network infrastructure using the identity of the subscriber.

12. A communication system according to claim 11 wherein each telephone terminal includes a token reader arranged to read data from a data storage token presented by a subscriber.

13. A communication system according to claim 12 wherein the token reader is a smart card reader or an inductive card reader.

14. A communication system according to claim 11 including a billing center which monitors calls made by subscribers and charges the calls to subscribers' accounts.

15. A communication system according to claim 11 wherein at least some of the terminals include a token reader/writer operable to read a credit value from a data storage token presented by a subscriber, and a processor operable to enable the telephone if the credit value exceeds a predetermined value and to cause the token reader/writer to reduce the credit value according to the cost of calls made.

16. A communication system according to claim 15 wherein the token reader is at least one of a magnetic card reader, an optical card reader, a smart card reader, and a non-contact card reader.

17. A communication system according to claim 12, wherein the data storage token comprising: a substrate; a data storage element operable to store data defining a telephone number allocated to a subscriber to the system; and an interface operable to transfer data to a telephone terminal of the system to identify the subscriber to the system.

18. A communication system according to claim 17 wherein the data storage element is arranged to store, in addition to data defining the subscriber's telephone number, data defining an identity code associated with the subscriber.

19. A communication system according to claim 18 wherein the identity code takes the form of at least one of a user-selected personal identity number (PIN) and a security code.

20. A communication system according to claim 17 which is further arranged to store data defining user information to be transmitted to the recipient of a call made by the subscriber, to identify the subscriber to the recipient.

21. A communication system according to claim 20 wherein the user information is determined by the subscriber.

22. (canceled)

23. (canceled)
